(19) United States
(12) Patent Application Publication
(10) Pub. No.: US 2009/0188844 A1
(43) Pub. Date: Jul. 30, 2009

(54) Construction & demolition debris (C&D) materials processing

(75) Inventors: William H. Davis, Winchester, MA (US); Irving B. Morrow, JR., Harvard, MA (US); Jeffrey E. Leech, Middleboro, MA (US)

Correspondence Address: LAW OFFICE OF DAVID H. JUDSON, 15950 DALLAS PARKWAY, SUITE 225, DALLAS, TX, 75248, US

(73) Assignee: Ze-gen, Inc., Boston, MA (US)

(21) Appl. No.: 12/021,987

(22) Filed: Jan. 29, 2008

(51) Int. Cl. B07B 13/04

(52) U.S. Cl. 209/659

(57) ABSTRACT

A method of processing construction and demolition (C&D) debris at a location includes a set of processing steps. The method begins upon receipt of bulk C&D debris at the location. The bulk C&D debris is sorted into at least a first portion for further processing, and a second portion that is set aside. The first portion is then processed into a substantially homogenous wood waste material having particles of a given size by the unordered steps of shredding, screening, metals separation and flotation. The substantially homogenous wood waste material is then dried so that the particles have moisture content within a desired range. The wood waste material particles are then delivered into a molten metal bath at a submerged depth for gasification. Preferably, the process operates in a continuous or partially-continuous manner within a given facility, or within co-located facilities.

### CROSS-REFERENCE TO RELATED APPLICATIONS

This application is related to the following commonly-owned application:

U.S. Ser. No. 11/400,973, filed Apr. 10, 2006, titled “Process and apparatus using a molten metal bath.”

### BACKGROUND OF THE INVENTION

1. Technical Field

This disclosure relates generally to waste handling.

2. Background of the Related Art

Current waste handling solutions typically rely on incineration and landfills. Waste incineration involves combustion, which creates undesirable by-products. Similarly, landfills represent the largest man-made source of methane gas emissions. In Massachusetts alone, over 13 million tons of municipal waste streams are generated each year, and once landfilled or incinerated, these waste streams result in over 10 million tons of CO₂ equivalent greenhouse gas emissions.

Construction and demolition debris (C&D) are waste products that are the result of the construction and/or demolition of roads, buildings or other physical structures. C&D waste is largely comprised of organic material, which is a good source of energy that municipalities traditionally waste by sending the material to a landfill. Techniques for processing C&D waste are well known, such as evidenced by U.S. Pat. No. 5,320,450.

Gasification of solid waste material also is a well-developed technology. One known approach involves injecting the waste material in to a molten metal bath in the presence of oxygen or other co-feeds. These systems are useful to produce useful output products (e.g., synthesis gas) and/or as inputs to other power generation equipment.

### BRIEF SUMMARY OF THE INVENTION

A method of processing construction and demolition (C&D) debris at a location includes a set of processing steps, namely, handling/sorting, pre-processing, post-processing, and gasification. In one embodiment, the method begins upon receipt of bulk C&D debris at the location. The bulk C&D debris is sorted into at least a first portion for further processing, and a second portion that is set aside. The first portion is then pre-processed into a substantially homogenous wood waste material having particles of a given size by the unordered steps of shredding, screening, metals separation and flotation. One or more of the shredding, screening, metals separation and flotation steps may be repeated or omitted as necessary. In a post-processing stage, the substantially homogenous wood waste material is then dried so that the particles have moisture content within a desired range. The wood waste material particles are then conveyed to a given location, e.g., above a gasifier, such as a molten metal bath. The material particles are then delivered into the molten metal bath at a submerged depth for gasification. Preferably, the process operates in a continuous or partially-continuous manner within a given facility, or within co-located facilities. If desired to maintain a substantially constant energy output from the gasifier, a secondary waste material may be blended with the wood waste prior to gasification.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a process flow diagram illustrating an embodiment of representative handling and sorting, and pre-processing stages of a continuous C&D processing facility according to this disclosure;

FIG. 2 is a process flow diagram illustrating an embodiment of representative post-processing and gasification stages of the continuous C&D processing facility;

FIG. 3 is a process flow diagram illustrating an alternative embodiment of the stages shown in FIG. 2; and

FIG. 4 is a perspective view of a representative C&D processing line in which the pre-processing stage may be carried out.

### DETAILED DESCRIPTION

According to this disclosure, a complete or end-to-end facility for processing construction and demolition waste (C&D) typically comprises several stages: C&D handling and sorting, C&D pre-processing, C&D debris post-processing, gasification, and, optionally, post-gasification/energy generation. It is not required that each of these stages is physically co-located in the same building, but it is desirable that the stages be carried out in close physical proximity where possible. Thus, in one embodiment, all of the stages are carried out in a single building, facility or enclosure; in an alternative embodiment, the handling and sorting, and pre-processing stages are performed in a first enclosure, while the post-processing and gasification stages are carried out in a second, nearby building, facility or enclosure. Preferably, the C&D processing takes place in a continuous or partially-continuous manner as bulk debris is received at the processing facility.

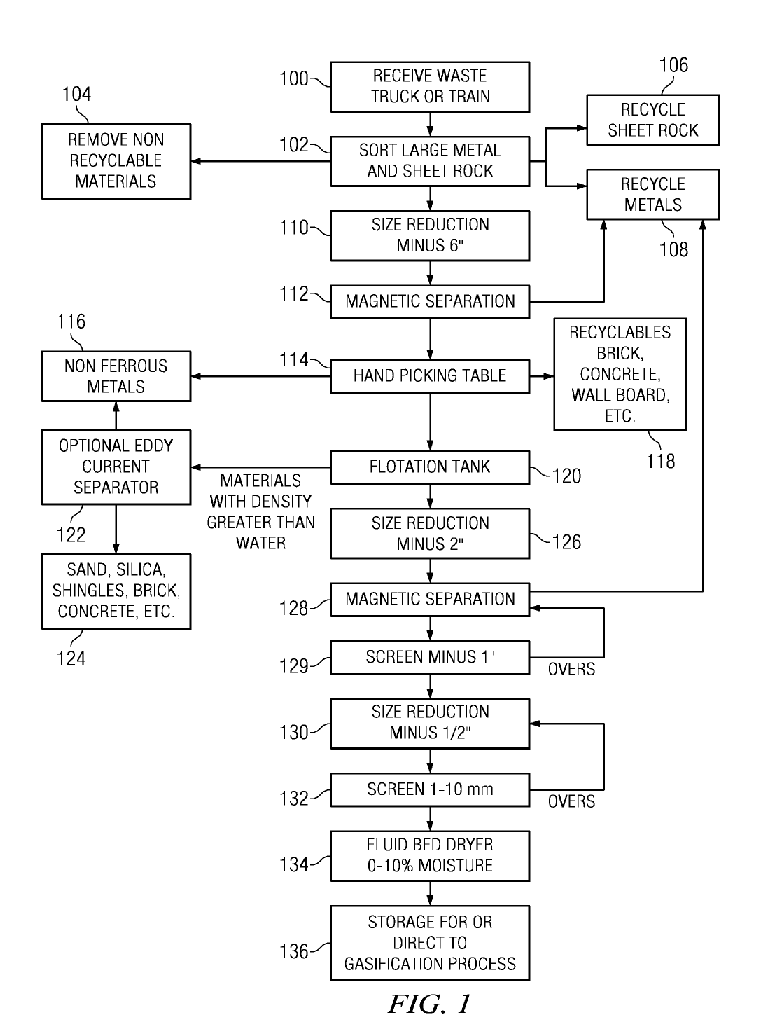

FIG. 1 is a process flow diagram illustrating an embodiment of the handling and sorting, and pre-processing stages. The process begins at step 100 upon receipt of the CD&D waste, typically by truck or train. At step 102, a bulk sort is carried out to remove large metal items, sheet rock, and the like. At step 104, non-recyclable materials are removed and put aside. Sheet rock is recycled at step 106, and metals are recycled at step 108. Steps 106 and 108 may occur in any convenient location. The material output from the bulk sort 102 is then reduced in size (e.g., less than six (6) inches) at step 110. At step 112, a magnetic separation is performed to remove residual metals. Any metals obtained from step 112 are returned to step 108 for recycling. At 114, the material is supplied to a hand-picking table, where one or more human operators (or automated equipment or systems) are positioned. At this point, non-ferrous metals are removed and put aside, as indicated by step 116; likewise, other recyclable materials, such as brick, concrete, wall board, and the like are removed and put aside, as indicated by step 118. After the picking table, the material preferably is delivered to a flotation tank, as indicated by step 120. Material with a density greater than water is removed by the flotation tank and supplied to an optional eddy current separator 122, which outputs non-ferrous metals 116, or other aggregate materials (e.g., sand, silica, shingles, brick, concrete, and the like), as indicated by numeral 124. Preferably, material output from the flotation tank step 120 is then reduced in size yet again (e.g., in this embodiment, to less than two (2) inches). This is step 126. A further magnetic separation 128 removes any still-remaining residual metals, which metals are then returned to step 108 for recycling, as before. The output of the second magnetic separation step 126 is then screened again at step 128, which (in this embodiment) produces material less than one (1) inch. Any “overs” (size-wise) are then returned to step 126 for additional magnetic separation and re-processing. Thereafter, the material is reduced in size still further (preferably less than one-half (½) inch). This is step 130. A further screening takes place at step 132 (preferably to between one-to-ten (1-10) mm), with any “overs” being returned to step 130 as illustrated. These size characteristics are merely illustrative. Step 132 typically is the last step in the pre-processing stage. Thereafter, and as will be described in more detail below, the resulting material is the subject to a drying step (e.g., in a fluid bed dryer) to reduce the moisture content to a preferred range (e.g., between about 0-10% moisture). This drying step is advantageous (and often necessary) because of the flotation tank processing, which adds significant moisture to the material. The fluid bed dryer operates at step 134, and it serves to reduce the moisture content of the material to a value sufficient to optimize the subsequent gasification of the material. At step 136, the material is delivered to a gasification process (or stored if necessary).

Thus, as can be seen, the material output from the above pre-processing is a solid waste of construction and demolition debris particles. In one embodiment, the material consists essentially of a homogeneous wood waste that has the physical consistency of mulch. There may be trace metal (such as portions of nails and the like) embedded in the wood waste particles. In a representative embodiment, the composition is a mixture or admixture of approximately 90+% wood, up to approximately 5% residual metal, and up to approximately 5% silica, perhaps with trace amounts of other materials, with the physical consistency of bulk mulch. A representative elemental analysis of the material received from the pre-processing stage (i.e., prior to drying) may then be as follows: moisture (24.21-27.11%), carbon (24.72-38.17%), hydrogen (2.91-4.06%), nitrogen (0.27-0.78%), sulfur (0.48-0.78%), ash (8.42-24.43%), and oxygen (19.78-24.36%). If it desired to increase the carbon content, one or more feedstock materials (such as tires, trap grease pellets, and the like) can be introduced during the pre-processing stage. For example, if the feedstock is augmented with trap grease pellets, the elemental analysis may then be adjusted as follows: moisture (6.6-27.11%), carbon (24.72-61.78%), hydrogen (2.91-7.99%), nitrogen (0.27-0.30%), sulfur (0.08-0.78%), ash (8.42-24.43%), and oxygen (8.25-24.36%).

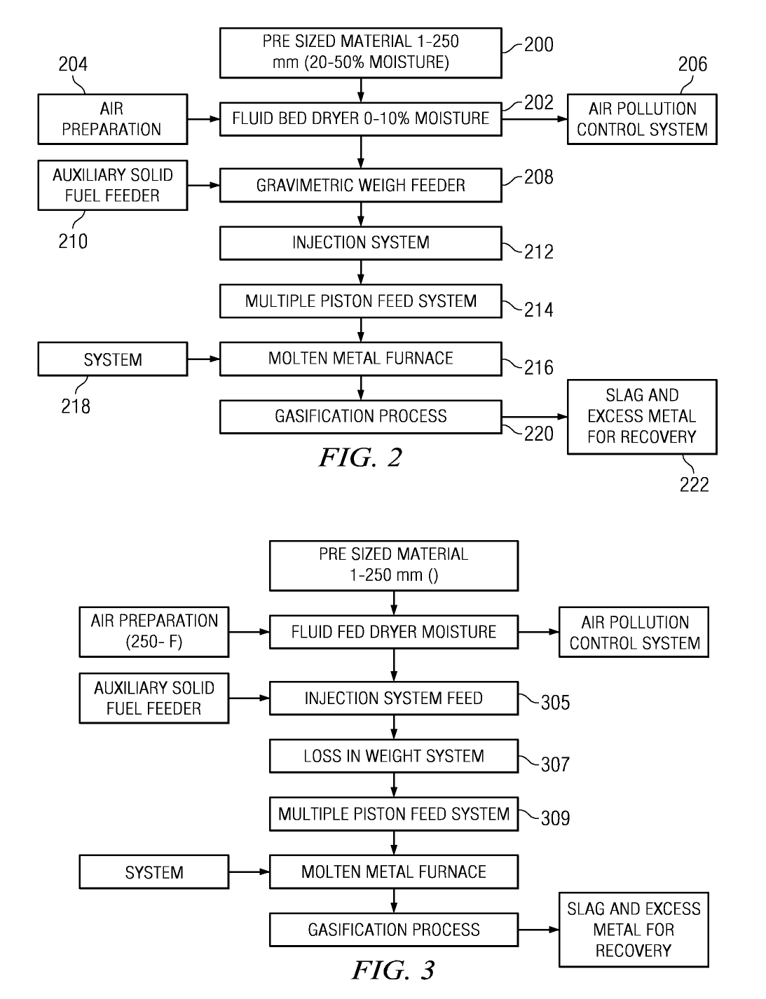

FIG. 2 is a process flow diagram illustrating an embodiment of the post-processing and gasification stages. The post-processing assumes material (as indicated by reference numeral 200) having a moisture content between about 20-50% due to the flotation tank processing. At this point, the material is about 1-250 mm in size. At step 202, the material is supplied to the fluid bed dryer (as described above with respect to FIG. 1), which reduces the moisture content to between about 0-10% by weight. In this embodiment, the fluid bed dryer is driven by heated air 204, and the output of dryer is supplied to an air pollution control system 206. In this embodiment, where an average gasification rate measured in hours is acceptable, the dried material is then supplied to a gravimetric weigh feeder at step 208. An auxiliary solid fuel feeding step 210 may be used to supplement the gravimetric weigh feeder if necessary. The output of the gravimetric weigh feeder is supplied to an injection system at step 212, such as a bucket elevator and a series of conveyors (mechanical or pneumatic). In this manner, the feed is delivered to a multiple piston feed system, as indicated at step 214. A multiple piston feed system supplies the material to a gasifier, such as a molten metal furnace, at step 216. In one embodiment, the molten metal bath is located within a refractory-lined vessel. Preferably, the vessel is not over-pressurized (i.e., operated above ATM pressure); alternatively, the techniques described herein may be carried out in a pressurized vessel. In one embodiment, the feed enters the vessel through a top-loaded feed tube, which injects the feed at a given submergence depth below the surface of a molten metal bath having a vitreous slag top layer. Other techniques for introducing the feed into the gasifier may be used as well. Upon entry into the metal bath, the waste material particles are exposed to elevated temperatures in excess of 1550° C., and as a consequence the material rapidly disassociates into elemental hydrogen and carbon. Carbon is oxidized to carbon monoxide by the oxygen content in the waste; thus, the primary reaction in the vessel is that the organic compounds in the waste should break down into C, CO and H₂. The residual carbon dissolves into the bath. This excess carbon is leached out of the bath by secondary O₂ injection, which is indicated by step 218. Gasification products include, for example, synthesis gas (a mixture of hydrogen and carbon monoxide). Collection of the off-gas is shown at step 220, and step 222 indicates that the slag and excess metal can be removed from the furnace and recovered as well.

FIG. 3 illustrates an alternative embodiment of the post-processing and gasification stages, where more precise injection rates are desired. In this embodiment, the gravimetric weigh feeder is omitted. The injection system (the bucket elevator, and associated conveyors) 305 supplies the material to a loss-in-weight system 307, which (in conjunction with the multiple piston feed system 309) provides more precise injection rates to the gasifier. Otherwise, the operation is similar to that described above.

As can be seen, the pre-processed C&D waste material is delivered to a feed system, preferably by means of mechanical or pneumatic conveying. Because it is desired to control the moisture content of the waste being delivered to the gasifier, as noted above, preferably a drying system (or, more generally, a drying step) is employed if the delivered waste material is not in the appropriate moisture range (e.g., <10%). From the dryer or initial conveying system, a secondary feed of a high BTU waste component, such as chlorinated or non chlorinated plastics, shredded tires or other solid waste, may be blended with the previously prepared solid waste to initiate a constant energy input product. This secondary feed is supplied by the auxiliary solid fuel feeding step 210, as indicated in FIG. 2. A system for performing this blending is described in Ser. No. 60/912,440, filed Apr. 24, 2007. The waste streams may be fed with volumetric gravimetric (FIG. 2) or volumetric (FIG. 3) feeders. The ratio of the multiple feed streams preferably is controlled by measuring the quality of the output gas and adjusting the input feed rates. The use of the gasification product influences the allowable rate variation of gas generation. If an average gasification rate as measured in hours is acceptable, as noted above a suitable injection system comprises a prepared waste elevating system (this is the injection system feed step 212) such as a bucket elevator, and a series of conveyors (mechanical or pneumatic), which operate with the piston feed system capable of injecting the wastes below the molten metal surface. Injection pistons can be controlled mechanically, pneumatically or hydraulically. If a more precise injection rate is desired (FIG. 3), the elevating of the waste is still desirable but feeds multiple loss-of-weight feeders or vessels. These vessels or feeders deliver the waste to one or more feed pistons. The measured loss in weight from the feed system or hopper is then utilized to control the injection feed system piston speed.

The following describes the handling and sorting, and pre-processing stages in more detail.

### C&D Handling & Sorting

This stage corresponds to steps 100, 102 and 104 of FIG. 1. In particular, C&D material delivered to the facility is sorted by material type/size prior to being processed in the pre-processing stage (which is a multi-step waste extraction/separation process, as will be described below). Thus, for example, C&D material is received at the facility and sorted using front-end loaders or an excavator equipped with a grapple attachment. The grapple separates and extracts from the waste stream bulky items such as wood, metals, particle board, and other unacceptable materials. Extracted bulky items are loaded into transfer trailers or roll-off containers and are transported to designated recycling/refuse markets. Extracted “unacceptable” materials are set aside.

### C&D Pre-Processing

After floor sorting, an excavator with grapple attachment loads the remaining C&D material into the main pre-processing equipment, which is now described. The following section corresponds generally to the remaining steps shown in FIG. 1, except steps 134 and 136.

Generally, as noted above, the pre-processing involves material shredding, and material screening. Preferably, there are two material screening sub-processes based on the size of the material output from the material shredding phase.

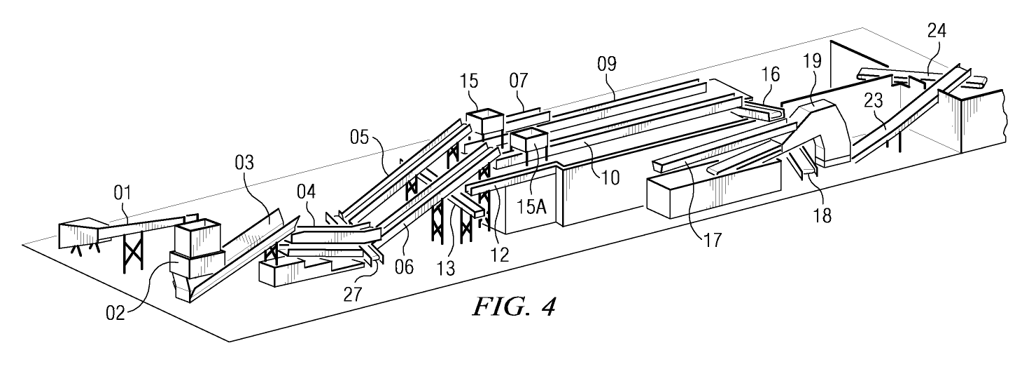

FIG. 4 illustrates one embodiment of the pre-processing line in perspective. The line comprises a shredder feed conveyor 1, a shredder 2, a shredder discharge conveyor 3, a primary vibration screener 4 (size approximately 6 inches), a “fines” incline conveyor 5, an “overs” incline conveyor 6, a secondary vibration screener 7 (size approximately 1 inch), a “fines” picking conveyor 9, an “overs” picking conveyor 10, a “fines” woods conveyor 11, an “overs” woods conveyor 12, a wood transfer conveyor 13, a “fines” magnet 15, an “overs” magnet 15A, a bidirectional transfer (rejects) picking conveyor 16, a bi-directional water tank conveyor 17, a rock transfer conveyor 18, a feed conveyor 19, a mill discharge conveyor 23, a discharge transfer conveyor 24, and a “fines” transfer conveyor 27.

The following describes the operation of the pre-processing stage in more detail.

Material Shredding Phase

The material is placed into the primary feed hopper that conveys the material to the primary shredder. The primary shredder reduces the material to less than 24″ (i.e. <24″) diameter. The shredded material (i.e. <24″) is then conveyed to a secondary feed hopper that conveys the material to a 6″ vibratory screen. The 6″ screen separates the waste into two size fractions (i.e. <6″ and >6″). Material leaving the 6″ screen drops onto a bi-directional conveyor that directs the material to the <6″ processing line.

Material Screening Phase (Material Greater Than 6″)

Material that is retained on the 6″ screen (i.e. >6″) may be conveyed past a blower/vacuum system for the removal of lightweight material (e.g. paper). The material then passes under a magnet to remove ferrous metals. The remaining >6″ material is then conveyed past manual picking lines/stations for the removal of various materials such as: non-ferrous metals, cardboard, and wood. Materials that are manually “picked” from the >6″ conveyor are deposited into awaiting chutes and designated recycling collection bins/bunkers (i.e. wood, metal, cardboard, and the like). The remaining >6″ material on the conveyor is then conveyed to a bi-directional conveyor system that conveys the material either to the grinder for additional processing and size reduction, or to a water floatation tank for the separation of lighter fraction waste recyclable materials (i.e., wood, cardboard, and the like). The grinding equipment reduces the material to <2-3″. Materials processed by the grinding equipment (i.e. <2-3″) are again run under a magnet to remove the smaller ferrous material exposed during the grinding operation. The remaining material is conveyed to and collected in the “fines/residual” bin/bunker. Material extracted by the water flotation tank, i.e. “floatable” (i.e. wood, cardboard, and the like) material, is then conveyed to the grinding equipment for additional processing (i.e. <2-3″). Materials sinking to the bottom of the water tank (e.g., aggregate) are extracted and placed/collected in a designated bin/bunker.

Material Screening Phase (Material Less Than 6″)

Material passing through the 6″ screen (i.e. <6″) is conveyed past an electro-magnet for the removal of ferrous metals and (as noted above) may be conveyed to a blower/vacuum system for the removal of light-weight material (e.g. paper). The remaining <6″ material is then conveyed past manual picking lines/stations for the removal of various materials such as: non-ferrous metals, cardboard, and wood. The remaining <6″ material on the conveyor is then conveyed to a 1″ vibratory screen. The 1″ vibratory screen separated the material into two size fractions (i.e. <1″ and >1″). Material passing through the vibratory screen (i.e. <1″) is conveyed to and collected in a designated bin/bunker as “fines.” Material is then conveyed into a picking room where material manually “picked” from the conveyor is deposited into designated chutes and collection bins/bunkers. Material then is transferred to a bi-directional conveyor system that conveys the >1″ material to either the grinding equipment for additional processing and size reduction, or to a water flotation tank for the separation of lighter fraction waste materials (i.e., wood, cardboard, and the like). The grinding equipment reduces the material to <2-3.” Material processed by the grinding equipment is then conveyed to and collected in the fines/residual bunker. Material extracted by the water floatation tank, i.e. “floatable” (i.e. wood, cardboard, and the like), is then conveyed to the grinding equipment for additional processing (i.e., <2-3″). Material sinking to the bottom of the water tank (e.g., aggregate) is extracted and placed/collected in designated bin/bunker.

Thus, an initial separation starts with inspection and gross separation of gypsum board, large metal objects, and the like. The pre-sorted wastes are conveyed to a magnetic separator, preferably followed by shredder system. Material is reduced in size to approximately 6″ (150 mm) followed by a hand picking table, another magnetic separator and a secondary shredder, and then separation of those particles under about 2″ (˜50 mm) in size, with the “overs” being recycled to a secondary shredder system. Depending on the material, particles may be required to be reduced in size to values between 0.1 mm to 50 mm. For size reductions below 2″ (˜50 mm) in size, tertiary grinding as well as particle size classification may be implemented. The classification may be accomplished by mechanical methods (screening), or air classification. As also described above, a step in the preparation of all sizes is the use of a float tank where all materials having a greater density than water sink with the balance floating. This flotation step separates from the feed stock materials such as non-ferrous metals, silica and the like.

The above-described C&D pre-processing operations are not meant to be limiting. Any pre-processing of C&D (e.g., by shredding) into a material having the physical characteristics described above may be used.

The above-described processing may be varied to facilitate handling of other materials, such as municipal solid waste (MSW). Thus, for MSW, the pre-processing phase typically includes an additional pre-grinding system and/or air separation system to remove lightweight materials such as plastics and paper. In addition, the path of the materials through the previously-described process may be varied, e.g., by performing the flotation tank operation earlier in the process.

As another variant, the waste may be pelletized, either before or after drying. Pelletizing the waste may reduce the drying requirements, as some of the moisture may be removed in the extrusion of the pellets.

While given components, equipment and systems have been described separately, one of ordinary skill will appreciate that some of the functions may be combined or shared.

Having described our invention, what we now claim is as follows.

1. A method of processing construction and demolition (C&D) debris in preparation for its gasification, comprising:
receiving bulk C&D debris;
sorting the bulk C&D debris into at least a first portion for further processing, and a second portion;
processing the first portion into a substantially homogenous wood waste material having particles of a given size between 1-50 mm by the unordered steps of shredding, screening, metals separation and flotation;
drying the substantially homogenous wood waste material so that the particles have a given moisture content; and
delivering the wood waste material particles into a molten metal bath at a submerged depth.

2. The method as described in claim 1 wherein the given size of the particles is less than six (6) inches.

3. The method as described in claim 1 wherein the given moisture content of the particles is less than approximately ten percent (10%).

4. The method as described in claim 1 wherein the given size of the particles is less than one (1) inch and the given moisture content is between zero and ten percent (0-10%).

5. The method as described in claim 1 wherein the flotation step removes material with a density greater than water.

6. The method as described in claim 1 wherein the processing of the first portion further includes picking material from the first portion.

7. The method as described in claim 1 wherein the second portion comprises large metal items, sheet rock, laminates, and non-recyclable materials.

8. The method as described in claim 1 wherein the delivering step includes blending the wood waste material particles with a secondary waste material.

9. The method as described in claim 8 wherein an amount of secondary waste material is blended to maintain a substantially constant energy associated with an off-gas delivered from the molten metal bath.

10. The method as described in claim 1 wherein the processing of the first portion includes first and second processes operating substantially concurrently and on material particles of different sizes.

11. The method as described in claim 1 wherein the wood waste material is substantially devoid of metal and chlorinated plastics.

12. The method as described in claim 1 wherein the steps are carried out within an integrated facility.

13. The method as described in claim 1 wherein the steps are carried out in first and second co-located facilities.

14. A method of processing debris, comprising:
receiving bulk debris that has been processed into a substantially homogenous material having particles between 1-50 mm, the material having a moisture content between zero and 10%; and
gasifying the material particles in a molten metal bath.

15. The method as described in claim 14 wherein the bulk debris is C&D material.

16. The method as described in claim 14 wherein the bulk debris is MSW material.
